(19) United States
(12) Patent Application Publication
(10) Pub. No.: US 2026/0067022 A1
(43) Pub. Date: Mar. 5, 2026

(54) SYSTEM AND METHOD OF AUTOMATIC TRACKING AND AIMING UNMANNED AERIAL VEHICLE

(71) Applicant: Iwavenology Co., Ltd., Kaohsiung City (TW)

(72) Inventors: Wei-Ting Tsai, Kaohsiung City (TW); Chong-Yi Liou, Kaohsiung City (TW); Shih-Ping Huang, Kaohsiung City (TW)

(73) Assignee: Iwavenology Co., Ltd., Kaohsiung City (TW)

(21) Appl. No.: 18/748,636

(22) Filed: Jun. 20, 2024

(30) Foreign Application Priority Data
May 16, 2024 (TW) 113118034

(51) Int. Cl. H04K 3/00; F41H 11/02

(52) U.S. Cl. CPC H04K 3/224; F41H 11/02

(57) ABSTRACT

A system of automatic tracking and aiming an unmanned aerial vehicle including a communication unit, an automatic tracking and aiming unit and an operation interface is disclosed. The communication unit is configured to obtain a detection information related to a target UAV from a UAV detection system. The automatic tracking and aiming unit is coupled to the communication unit and configured to enter a tracking mode for the target UAV and generate an automatic tracking and aiming information according to the detection information. The operation interface is coupled to the automatic tracking and aiming unit and configured to provide the automatic tracking and aiming information to assist a user to operate a drone countermeasure device to aim at the target UAV and emit an interference signal.

### BACKGROUND OF THE INVENTION

### 1. Field of the Invention

The invention relates to an unmanned aerial vehicle (UAV); in particular, to a system and a method of automatic tracking and aiming UAV.

### 2. Description of the Prior Art

In general, when a user wants to use a UAV drone countermeasure device to send out interference signals to a UAV flying in the sky, it is often necessary to adjust the launch angle of the UAV drone countermeasure device through visual aiming, so that the interference signal emitted by the UAV drone countermeasure device can be accurately shot to the UAV in the sky.

However, because the UAV flying in the sky is too far away from the user and the UAV continues to fly quickly, and when outdoors, it is easy to be affected by external environmental factors such as sunlight, rain, wind and sand, etc., which will prevent users from smoothly operating the UAV drone countermeasure device to accurately emit interference signals to the UAV in the sky. As a result, the task of interfering with the UAV cannot be completed satisfactorily.

Therefore, the above-mentioned problems encountered by the prior art still need to be solved.

### SUMMARY OF THE INVENTION

Therefore, the invention provides a system and a method of automatic tracking and aiming UAV to solve the above-mentioned problems of the prior arts.

A preferred embodiment of the invention is an UAV automatic tracking and aiming system. In this embodiment, the UAV automatic tracking and aiming system includes a communication unit, an automatic tracking and aiming unit and an operation interface. The communication unit is configured to obtain a detection information related to a target UAV from a UAV detection system. The automatic tracking and aiming unit is coupled to the communication unit and configured to enter a tracking mode for the target UAV and generate an automatic tracking and aiming information according to the detection information. The operation interface is coupled to the automatic tracking and aiming unit and configured to provide the automatic tracking and aiming information to assist a user to operate a drone countermeasure device to aim at the target UAV and emit an interference signal.

In an embodiment, the operation interface is an electronic device externally connected to the drone countermeasure device, or the operation interface is a touch interface or a non-touch interface embedded in the drone countermeasure device.

In an embodiment, a display screen of the operation interface has a function of displaying whether an elevation or horizontal angle of the drone countermeasure device emitting the interference signal is allowable according to an information about the location and height of restricted area in the surrounding environment assigned by a geographic information system.

In an embodiment, the detection information includes coordinates, altitude, height above ground, speed, brand, model, transmission frequency band, transmission bandwidth, transmission power, and receiving noise ratio of the target UAV, distance between the target UAV and the drone countermeasure device, distance between the target UAV and remote control, coordinates and altitude of remote control, coordinates, altitude, transmit power, transmit frequency band, and radiation field pattern of the drone countermeasure device, coordinates, altitude, height above ground, frequency band, orientation, detection distance, antenna radiation field type of detection device, whether the detection function of detection device is enabled, and the electromagnetic shielding condition of the surrounding environment.

In an embodiment, the UAV automatic tracking and aiming system is embedded in the UAV detection system and enters a tracking mode for the target UAV.

In an embodiment, in the tracking mode, a crosshair representing an aiming direction of the drone countermeasure device is displayed in on a display screen of the operation interface and a recommended interference range generated by the automatic tracking and aiming unit according to the detection information is also displayed on the display screen of the operation interface.

In an embodiment, when the recommended interference range changes due to a horizontal angle and an elevation angle of the drone countermeasure device, causing the crosshair to be outside the recommended interference range, the drone countermeasure device is correspondingly adjusted by the user to bring the crosshair back within the recommended interference range.

In an embodiment, the automatic tracking and aiming unit also generates a recommended interference time according to the detection information; if the drone countermeasure device continues to target at least one partial region of the recommended interference range for more than the recommended interference time, the at least one partial region is regarded as a scanned region, and a display state of the at least one partial region on the display screen is changed to remind the user to adjust the drone countermeasure device to target other unscanned regions of the recommended interference range.

In an embodiment, the automatic tracking and aiming unit also generates a state prompt related to the target UAV according to the detection information and the state prompt is displayed on the display screen to indicate effects of the drone countermeasure device emitting the interference signal to interfere with the target UAV; when the target UAV is in an abnormal state, the state prompt is to change a display state of an aiming region of the drone countermeasure device to indicate that the drone countermeasure device has successfully interfered with the target UAV.

In an embodiment, the drone countermeasure device is fixedly or non-fixedly disposed.

In an embodiment, the interference signal emitted by the drone countermeasure device is a composite interference signal including different frequencies, bandwidths, powers, phases and modulations; the drone countermeasure device has an automatic interference function, and whether to enable the automatic interference function is set through the operation interface or a switch on the drone countermeasure device, when the automatic interference function is enabled, if the crosshair displayed on the display screen of the operation interface is in an unscanned region or the drone countermeasure device is determined to be aimed at the target UAV, the drone countermeasure device automatically selects the appropriate composite interference signal for jamming based on the detection information. If the crosshair displayed on the display screen of the operation interface is determined not to be within the recommended interference range, the crosshair is not aimed at the target UAV, the target UAV has been successfully interfered, or the target UAV has lost its threat (has returned, landed, and is outside the warning range), then the drone countermeasure device automatically stops jamming.

In an embodiment, the drone countermeasure device has an interference protection function, and whether to enable the interference protection function is set through the operation interface or a switch on the drone countermeasure device; when the interference protection function is enabled, the UAV detection system temporarily disables some or all of detection functions, so that the automatic tracking and aiming system can remove some or all of interference restrictions; if the automatic tracking and aiming system determines that an interference direction of the drone countermeasure device affects the detection device based on the detection information, the interference limitation function is triggered and a warning is issued on the operation interface; when the interference limitation function is triggered, some or all of the interference functions of the drone countermeasure device are limited and the interference limitation function can be manually released through the operation interface.

Another preferred embodiment of the invention is an UAV automatic tracking and aiming method. In this embodiment, the UAV automatic tracking and aiming method includes steps of: obtaining a detection information related to a target UAV from a UAV detection system; entering a tracking mode for the target UAV and generating an automatic tracking and aiming information according to the detection information; and providing the automatic tracking and aiming information to assist a user to operate a drone countermeasure device to aim at the target UAV and emit an interference signal.

In an embodiment, the detection information includes coordinates, altitude, height above ground, speed, brand, model, transmission frequency band, transmission bandwidth, transmission power, and receiving noise ratio of the target UAV, distance between the target UAV and the drone countermeasure device, distance between the target UAV and remote control, coordinates and altitude of remote control, coordinates, altitude, transmit power, transmit frequency band, and radiation field pattern of the drone countermeasure device, coordinates, altitude, height above ground, frequency band, orientation, detection distance, antenna radiation field type of detection device, whether the detection function of detection device is enabled, and the electromagnetic shielding condition of the surrounding environment.

In an embodiment, the UAV automatic tracking and aiming method further includes steps of: entering the tracking mode for the target UAV; displaying a crosshair representing an aiming direction of the drone countermeasure device in a crosshair of a display screen; displaying a recommended interference range generated according to the detection information is on the display screen; and displaying whether an elevation or horizontal angle of the drone countermeasure device emitting the interference signal is allowable according to an information about the location and height of restricted area in the surrounding environment assigned by a geographic information system.

In an embodiment, the UAV automatic tracking and aiming method further includes steps of: when the recommended interference range changes due to a horizontal angle and an elevation angle of the drone countermeasure device, causing the crosshair to be outside the recommended interference range, correspondingly adjusting the drone countermeasure device to bring the crosshair back within the recommended interference range.

In an embodiment, the UAV automatic tracking and aiming method further includes steps of: generating a recommended interference time according to the detection information; if the drone countermeasure device continues to target at least one partial region of the recommended interference range for more than the recommended interference time, regarding the at least one partial region as a scanned region; and changing a display state of the at least one partial region on the display screen to remind the user to adjust the drone countermeasure device to target other unscanned regions of the recommended interference range.

In an embodiment, the UAV automatic tracking and aiming method further includes steps of: generating a state prompt related to the target UAV according to the detection information and displaying the state prompt on the display screen to indicate effects of the drone countermeasure device emitting the interference signal to interfere with the target UAV, wherein when the target UAV is in an abnormal state, the state prompt is to change a display state of an aiming region of the drone countermeasure device to indicate that the drone countermeasure device has successfully interfered with the target UAV.

In an embodiment, the drone countermeasure device is fixedly or non-fixedly disposed; the interference signal emitted by the drone countermeasure device is a composite interference signal including different frequencies, bandwidths, powers, phases and modulations; the UAV automatic tracking and aiming method further includes steps of: enabling the automatic interference function of the drone countermeasure device; if the crosshair of the operation interface is in an unscanned region or the drone countermeasure device is determined to be aimed at the target UAV, the drone countermeasure device automatically selecting the appropriate composite interference signal for jamming based on the detection information; and if the crosshair of the operation interface is determined not to be within the recommended interference range, the crosshair is not aimed at the target UAV, the target UAV has been successfully interfered, or the target UAV has lost its threat (has returned, landed, and is outside the warning range), then the drone countermeasure device automatically stopping jamming.

In an embodiment, the UAV automatic tracking and aiming method further includes steps of: enabling the interference protection function; the UAV detection system temporarily disabling some or all of detection functions, so that the automatic tracking and aiming system can remove some or all of interference restrictions; if the automatic tracking and aiming system determines that the interference direction of the drone countermeasure device affects the detection device based on the detection information, triggering the interference limitation function and issuing a warning on the operation interface; and when the interference limitation function is triggered, limiting some or all of the interference functions of the drone countermeasure device and the interference limitation function can be manually released through the operation interface.

Compared to the prior art, the UAV automatic tracking and aiming system and method of the invention can effectively generate instruction information based on the position information of one or more UAVs to guide the user to correctly operate and adjust the state of the UAV drone countermeasure device, Even if the UAV is too far away and flying too fast or is affected by external environmental factors such as sunlight, rain, wind and sand, the user can still operate the UAV drone countermeasure device smoothly according to the instruction information provided by the electronic device accurately emit interference signals to the UAV, and successfully achieve the task of interfering with UAV.

The advantage and spirit of the invention may be understood by the following detailed descriptions together with the appended drawings.

### BRIEF DESCRIPTION OF THE APPENDED DRAWINGS

FIG. 1 illustrates a schematic diagram of the UAV automatic tracking and aiming system in the first preferred embodiment of the invention.

FIG. 2A and FIG. 2B respectively illustrate a front view and a side view of the UAV automatic tracking and aiming system disposed on the drone countermeasure device.

FIG. 3A to FIG. 3G respectively illustrate different embodiments of the display screen of the operation interface.

FIG. 4 illustrates a flowchart of the UAV automatic tracking and aiming method in the second preferred embodiment of the invention.

FIG. 5 to FIG. 8 respectively illustrate flowcharts of the UAV automatic tracking and aiming method in other embodiments of the invention.

### DETAILED DESCRIPTION OF THE INVENTION

According to a first preferred embodiment of the invention, an unmanned aerial vehicle (UAV) automatic tracking and aiming system is used to automatically track and aim a target unmanned aerial vehicle and can provide automatic tracking and aiming information to assist a user to operate a drone countermeasure device to emit an interference signal to the target unmanned aerial vehicle, but not limited to this.

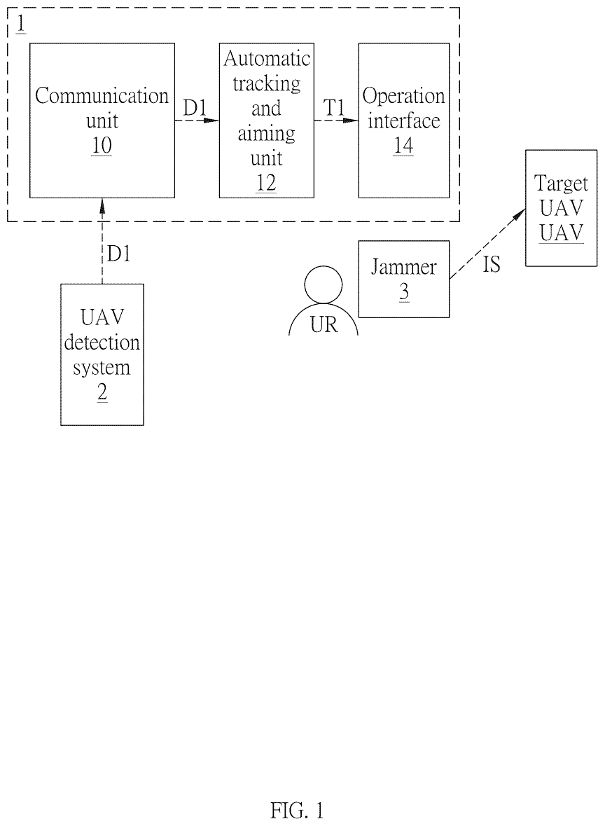

Please refer to FIG. 1. FIG. 1 illustrates a schematic diagram of the unmanned aerial vehicle automatic tracking and aiming system in the first preferred embodiment of the invention. As shown in FIG. 1, the unmanned aerial vehicle automatic tracking and aiming system 1 includes a communication unit 10, an automatic tracking and aiming unit 12 and an operation interface 14. The automatic tracking and aiming unit 12 is coupled to the communication unit 10. The operation interface 14 is coupled to the automatic tracking and aiming unit 12. The communication unit 10 is used to obtain a detection information DI related to the target unmanned aerial vehicle UAV from an unmanned aerial vehicle detection system 2 and transmit the detection information DI to the automatic tracking and aiming unit 12. The automatic tracking and aiming unit 12 is used to enter a tracking mode for the target unmanned aerial vehicle UAV and generate an automatic tracking and aiming information T1 to the operation interface 14 based on the detection information DI. The operation interface 14 is used to provide the automatic tracking and aiming information T1 to assist a user UR to operate a drone countermeasure device 3 to aim at the target unmanned aerial vehicle UAV and emit an interference signal IS toward the target unmanned aerial vehicle UAV.

In practical applications, the operation interface 14 of the unmanned aerial vehicle automatic tracking and aiming system 1 can be an electronic device externally connected to the drone countermeasure device 3, or a touch interface or a non-touch interface embedded in the drone countermeasure device 3. For example, there are no specific restrictions on the display screen embedded in the drone countermeasure device 3 that emits the interference signal IS. The drone countermeasure device 3 can be fixedly or non-fixedly disposed. The interference signal IS emitted by the drone countermeasure device 3 can include composite interference signals of different frequencies, bandwidths, powers, phases and modulations, but not limited to this.

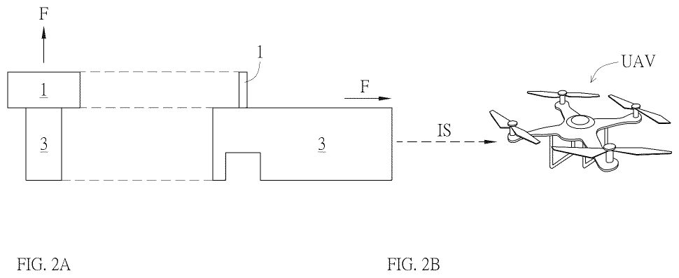

Please refer to FIG. 2A and FIG. 2B. FIG. 2A and FIG. 2B illustrate a front view and a side view of the unmanned aerial vehicle automatic tracking and aiming system 1 disposed on the drone countermeasure device 3 respectively. As shown in FIG. 2A and FIG. 2B, the unmanned aerial vehicle automatic tracking and aiming system 1 disposed on the drone countermeasure device 3 can generate the automatic tracking and aiming information TI based on the detection information DI of the target unmanned aerial vehicle UAV from the UAV detection system 2 and the automatic tracking and aiming information TI can assist the user UR to operate the drone countermeasure device 3 to aim at the target unmanned aerial vehicle UAV and emit the interference signal IS.

In practical applications, the detection information DI provided by the unmanned aerial vehicle detection system 2 can include coordinates, altitude, height above ground, speed, brand, model, transmission frequency band, transmission bandwidth, transmission power, and receiving noise ratio of the target unmanned aerial vehicle UAV, distance between the target unmanned aerial vehicle UAV and the drone countermeasure device 3, distance between the target unmanned aerial vehicle UAV and remote control, coordinates and altitude of remote control, coordinates, altitude, transmit power, transmit frequency band, and radiation field pattern of the drone countermeasure device 3, coordinates, altitude, height above ground, frequency band, orientation, detection distance, antenna radiation field type of detection device, whether the detection function of detection device is enabled, and the electromagnetic shielding condition of the surrounding environment, etc., but not limited to this.

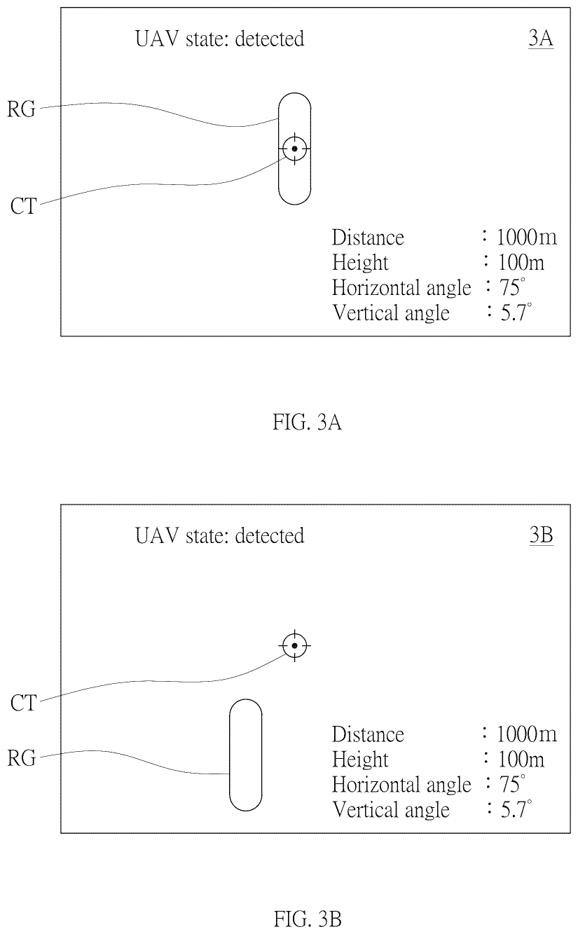

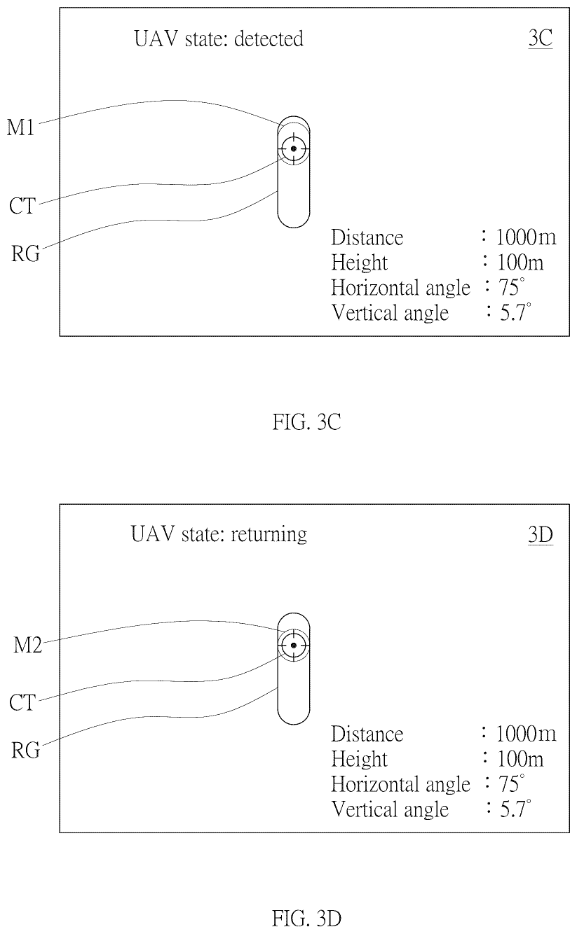

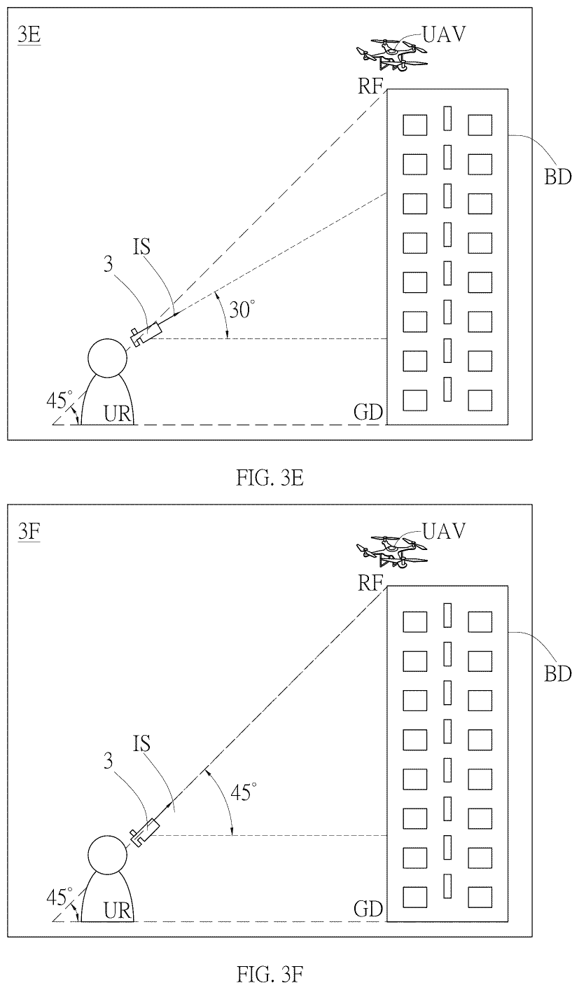

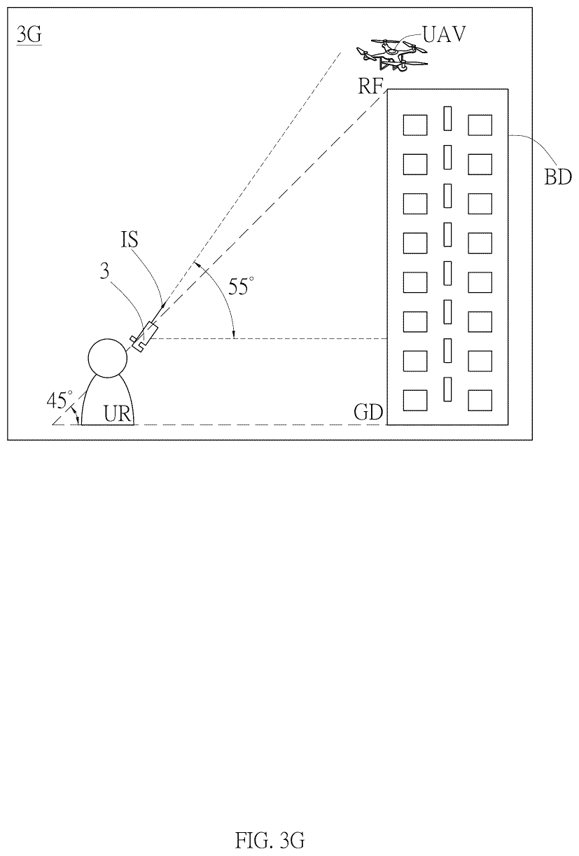

In other embodiments, the automatic tracking and aiming system 1 can also be embedded in the unmanned aerial vehicle detection system 2 and enter the tracking mode for the target unmanned aerial vehicle UAV. Please refer to FIG. 3A to FIG. 3D, which respectively illustrate different embodiments of the display screen of the operation interface 14 of the automatic tracking and aiming system 1.

As shown in FIG. 3A, in the tracking mode, a crosshair CT representing the aiming direction of the drone countermeasure device 3 is displayed in the center of the display screen 3A of the operation interface 14 and the display screen 3A also displays a recommended interference range RG generated by the automatic tracking and aiming unit 12 based on the detection information DI. Under the ideal situation, the crosshair CT of the aiming direction of the drone countermeasure device 3 displayed in the display screen 3A will be within the recommended interference range RG. The upper left corner of the display screen 3A displays the detection information DI such as “UAV state: detected” and the lower right corner of the display screen 3A displays “Distance: 1000 m”, “Height: 100 m”, “Horizontal angle: 75°” and “Vertical angle: 5.7°”, but not limited to this.

As shown in FIG. 3B, the position of the recommended interference range RG in the display screen 3B changes due to the changes in the horizontal angle and elevation angle of the drone countermeasure device 3. As a result, the crosshair CT of the aiming direction of the drone countermeasure device 3 will be outside the recommended interference range RG. At this time, the user UR can correspondingly adjust the drone countermeasure device 3, so that the crosshair CT of the aiming direction of the drone countermeasure device 3 displayed on the display screen 3B can return to the recommended interference range RG.

In another embodiment, the automatic aiming unit 12 can also generate a recommended interference time (for example, 10 seconds) based on the detection information DI. If the drone countermeasure device 3 continues to target at least one partial region of the recommended interference range RG for more than the recommended interference time, as shown in FIG. 3C, the at least one partial region of the recommended interference range RG displayed on the display screen 3C will be regarded as a scanned region M1, and the display screen 3C will change the display state (for example, change the display color) of the scanned region M1 to remind the user UR should adjust the horizontal angle and the elevation angle of the drone countermeasure device 3 to target other unscanned regions in the recommended interference range RG, but not limited to this.

In another embodiment, the automatic tracking and aiming unit 12 can also generate a state prompt related to the target unmanned aerial vehicle UAV based on the detection information DI and display the state prompt on the display screen to indicate the effectiveness of the drone countermeasure device 3 emitting the interference signal IS to interfere with the target unmanned aerial vehicle UAV. For example, as shown in FIG. 3D, when the target unmanned aerial vehicle UAV is in an abnormal state, the state prompt related to the target unmanned aerial vehicle UAV displayed on the display screen 3D is to change the display state (for example, changing the display color) of the aiming region M2 of the drone countermeasure device 3 to indicate that the drone countermeasure device 3 has successfully interfered with the target unmanned aerial vehicle UAV, but not limited to this. In addition, the state displayed in the upper left corner of the display screen 3D changes to “UAV state: returning” and the other detection information DI “distance: 1000 m”, “height: 100 m”, and “horizontal angle: 75°” and “vertical angle: 5.7°” are displayed in the lower right corner of the display screen 3D, but not limited to this.

In another embodiment, the drone countermeasure device 3 can have an automatic interference function, and whether to enable the automatic interference function can be set by the operation interface 14 or a switch on the drone countermeasure device 3. When the automatic interference function is enabled, if the crosshair CT displayed on the display screen of the operation interface 14 is in an unscanned region or the drone countermeasure device 3 is determined to have aimed at the target unmanned aerial vehicle UAV, the drone countermeasure device 3 will automatically select the appropriate composite interference signal for interference based on the detection information DI. If the crosshair CT displayed on the display screen of the operation interface is determined not to be within the recommended interference range RG, the crosshair CT is not aimed at the target unmanned aerial vehicle UAV, the drone countermeasure device 3 has successfully interfered with the target unmanned aerial vehicle UAV, or the target unmanned aerial vehicle UAV has lost its threat (for example, the target unmanned aerial vehicle UAV has returned, landed, or is outside the warning range), the drone countermeasure device 3 will automatically stop interfering, but not limited to this.

In another embodiment, the automatic tracking and aiming system 1 can have an interference protection function, and whether to enable the interference protection function can be set by the switch on the operation interface 14 or the drone countermeasure device 3. When the interference protection function is enabled, the unmanned aerial vehicle detection system 2 will temporarily disable some or all of detection functions, so that the automatic tracking and aiming system 1 can remove some or all of interference restrictions. If the automatic tracking and aiming system 1 determines that the interference direction of the drone countermeasure device 3 will affect the detection device based on the detection information DI, the interference limitation function is triggered and a warning is issued on the operation interface 14. When the interference limiting function is triggered, some or all of interference functions of the drone countermeasure device 3 will be limited and the interference limiting function can be manually released through the operation interface 14, but not limited to this.

It should be also noted that when the user operates the drone countermeasure device 3 to aim at the target unmanned aerial vehicle UAV, it is also important to consider whether the elevation angle of the drone countermeasure device 3 emitting the interference signal affects the safety of buildings, people and property in the surrounding environment.

Therefore, in another embodiment, the display screen of the operation interface 14 can also have a function of displaying the information about whether the elevation or horizontal angle of the drone countermeasure device 3 emitting the interference signal is allowable according to an information about the location and height of restricted area (for example, buildings) in the surrounding environment assigned by a geographic information system (for example, the google map system), but not limited to this.

For example, as shown in FIG. 3E, if there is a 50-story building BD to the east of the user UR, and the elevation angle between the roof RF and the ground GD of the building BD is 45°. When the user UR operates the drone countermeasure device 3 to aim toward the east to emit the interference signal IS and the elevation angle of the drone countermeasure device 3 is 30°, the interference signal IS emitted by the drone countermeasure device 3 is likely to cause interference to the people and electronic devices in the building BD.

At this time, the display screen 3E of the operation interface 14 can display a first display state (for example, red color) to show it is dangerous that the elevation angle of the drone countermeasure device 3 toward the east is too low and the people and electronic devices in the building BD might be affected by the interference signal IS emitted by the drone countermeasure device 3, so it can remind the user UR to raise the drone countermeasure device 3 to increase the elevation angle of the drone countermeasure device 3.

As shown in FIG. 3F, when the user UR continues to raise the drone countermeasure device 3 and the elevation angle of the drone countermeasure device 3 is increased to about 45°, the display screen 3F of the operation interface 14 can display a second display state (for example, yellow color) to show it is possible that the people and electronic devices in the roof RF of the building BD might be affected by the interference signal IS emitted by the drone countermeasure device 3, so it is better for the user UR to continue to raise the drone countermeasure device 3 to increase the elevation angle of the drone countermeasure device 3.

As shown in FIG. 3G, when the user UR continues to raise the drone countermeasure device 3 and the elevation angle of the drone countermeasure device 3 is increased to over 55°, it is believed that the people and electronic devices in the whole building BD will not be affected by the interference signal IS emitted by the drone countermeasure device 3, so the display screen 3G of the operation interface 14 can display a third state (for example, green color) to show it is safe now that the elevation angle of the drone countermeasure device 3 toward the east is high enough to aim at the target unmanned aerial vehicle UAV without affecting the people and electronic devices in the building BD.

As a result, in this embodiment of the invention, the display screen of the operation interface 14 can not only display the coordinate position of the drone countermeasure device 3, when the user UR operates the drone countermeasure device 3 at the coordinate position to emit the interference signal IS toward different directions, the display screen of the operation interface 14 can also display the safe elevation angles of the drone countermeasure device 3 for different directions correspondingly to remind the user UR to adjust the elevation angle of the drone countermeasure device 3 to prevent the buildings, people and property in the surrounding environment from being affected, but not limited to this.

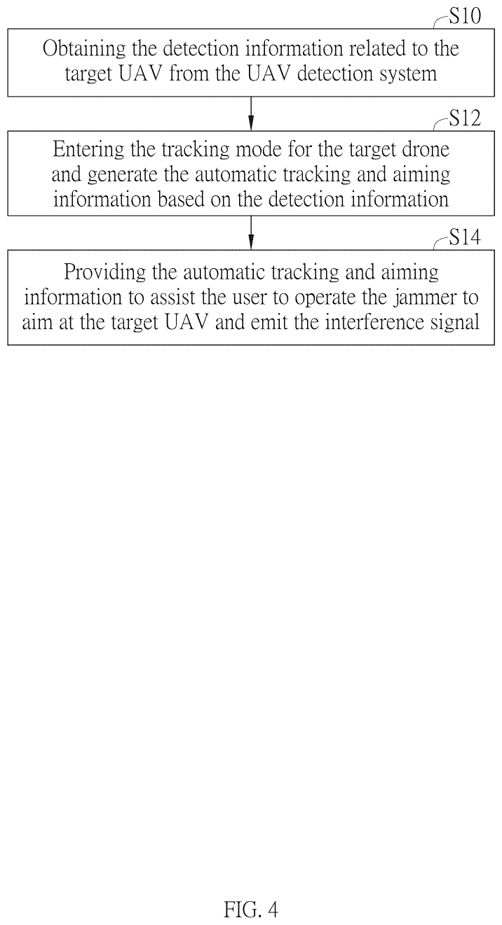

A second preferred embodiment according to the invention is an automatic tracking and aiming method for an unmanned aerial vehicle. Please refer to FIG. 4, which illustrates a flowchart of the unmanned aerial vehicle automatic tracking and aiming method in this embodiment. As shown in FIG. 4, the UAV automatic tracking and aiming method includes the following steps of:

Step S10: obtaining the detection information related to the target UAV from the UAV detection system;

Step S12: entering the tracking mode for the target drone and generate the automatic tracking and aiming information based on the detection information; and

Step S14: providing the automatic tracking and aiming information to assist the user to operate the drone countermeasure device to aim at the target UAV and emit the interference signal.

In practical applications, the detection information can include coordinates, altitude, height above ground, speed, brand, model, transmission frequency band, transmission bandwidth, transmission power, and receiving noise ratio of the target unmanned aerial vehicle, distance between the target unmanned aerial vehicle and the drone countermeasure device, distance between the target unmanned aerial vehicle and remote control, coordinates and altitude of remote control, coordinates, altitude, transmit power, transmit frequency band, and radiation field pattern of the drone countermeasure device, coordinates, altitude, height above ground, frequency band, orientation, detection distance, antenna radiation field type of detection device, whether the detection function of detection device is enabled, and the electromagnetic shielding condition of the surrounding environment, etc., but not limited to this.

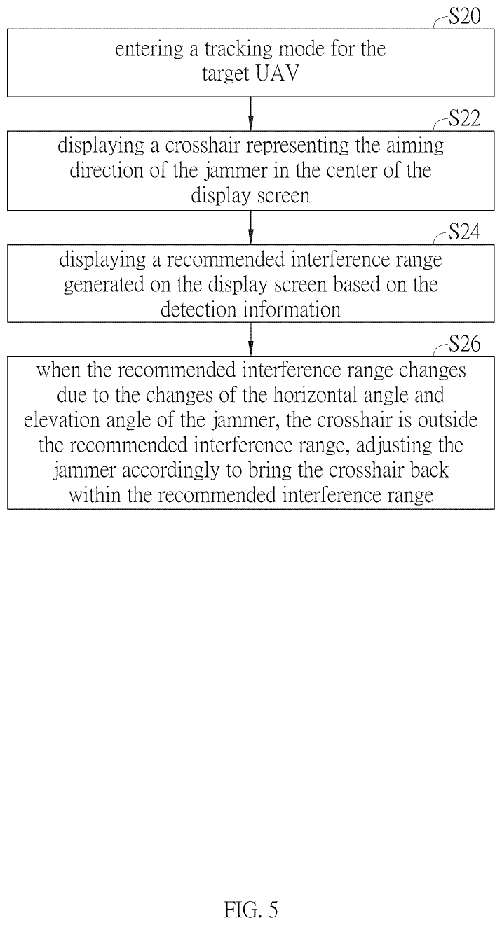

As shown in FIG. 5, in another embodiment, the UAV automatic tracking and aiming method may also include the following steps of:

Step S20: entering a tracking mode for the target UAV;

Step S22: displaying a crosshair representing the aiming direction of the drone countermeasure device in the center of the display screen;

Step S24: displaying a recommended interference range generated on the display screen based on the detection information; and

Step S26: when the recommended interference range changes due to the changes of the horizontal angle and elevation angle of the drone countermeasure device, the crosshair is outside the recommended interference range, adjusting the drone countermeasure device accordingly to bring the crosshair back within the recommended interference range.

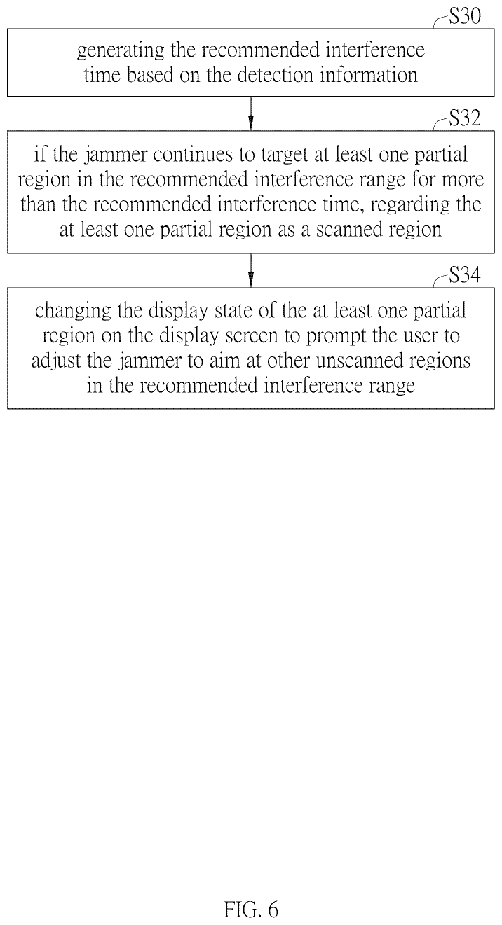

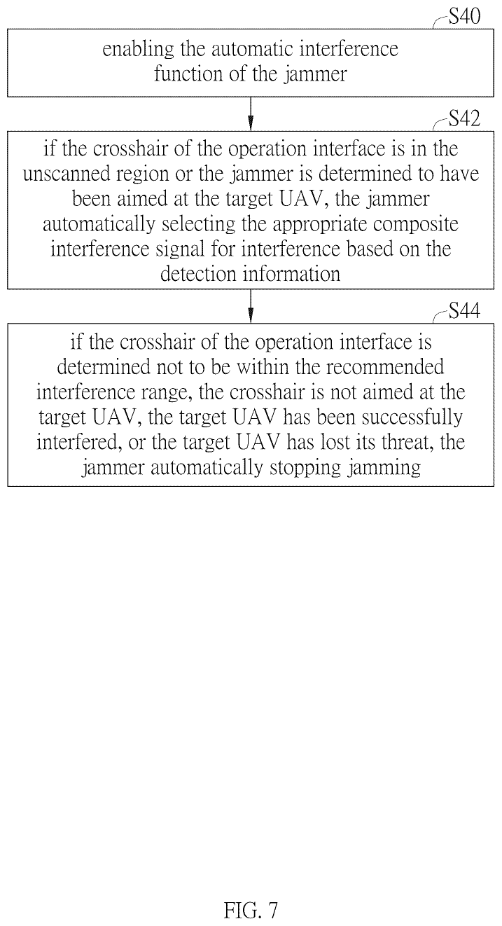

As shown in FIG. 6, in another embodiment, the UAV automatic tracking and aiming method may also include the following steps of:

Step S30: generating the recommended interference time based on the detection information;

Step S32: if the drone countermeasure device continues to target at least one partial region in the recommended interference range for more than the recommended interference time, regarding the at least one partial region as a scanned region; and

Step S34: changing the display state of the at least one partial region on the display screen to prompt the user to adjust the drone countermeasure device to aim at other unscanned regions in the recommended interference range.

In practical applications, the UAV automatic tracking and aiming method can also generate a state prompt related to the target UAV based on the detection information and display the state prompt on the display screen to indicate the effectiveness that the drone countermeasure device emits the interference signal to interfere with the target UAV. For example, when the target UAV is in an abnormal state, the state prompt is to change the display state of the aiming region of the drone countermeasure device to prompt that the drone countermeasure device has successfully interfered with the target UAV.

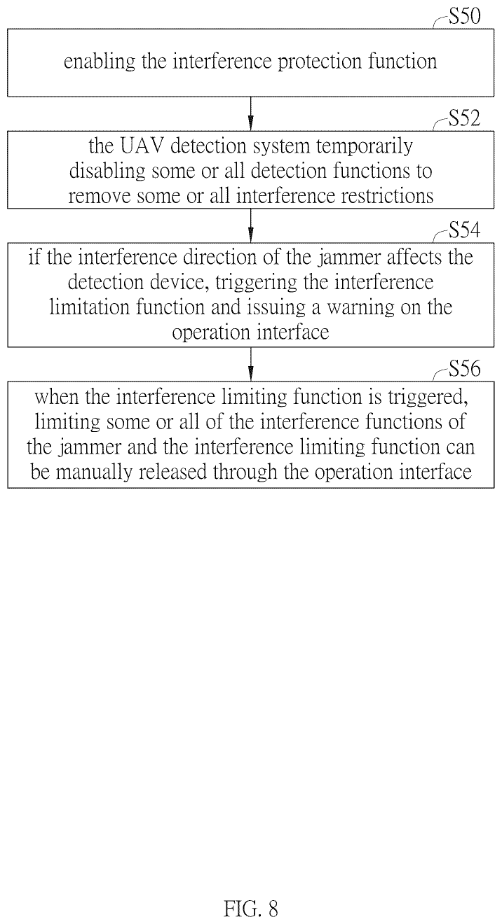

As shown in FIG. 7, in another embodiment, the UAV automatic tracking and aiming method may also include the following steps of:

Step S40: enabling the automatic interference function of the drone countermeasure device;

Step S42: if the crosshair of the operation interface is in the unscanned region or the drone countermeasure device is determined to have been aimed at the target UAV, the drone countermeasure device automatically selecting the appropriate composite interference signal for interference based on the detection information; and

Step S44: if the crosshair of the operation interface is determined not to be within the recommended interference range, the crosshair is not aimed at the target UAV, the target UAV has been successfully interfered, or the target UAV has lost its threat (for example, it has returned home, landing, outside the warning range), the drone countermeasure device automatically stopping jamming.

As shown in FIG. 8, in another embodiment, the UAV automatic tracking and aiming method may also include the following steps of:

Step S50: enabling the interference protection function;

Step S52: the UAV detection system temporarily disabling some or all detection functions to remove some or all interference restrictions;

Step S54: if the interference direction of the drone countermeasure device affects the detection device, triggering the interference limitation function and issuing a warning on the operation interface; and

Step S56: when the interference limiting function is triggered, limiting some or all of the interference functions of the drone countermeasure device and the interference limiting function can be manually released through the operation interface.

Compared to the prior art, the UAV automatic tracking and aiming system and method of the invention can effectively generate instruction information based on the position information of one or more UAVs to guide the user to correctly operate and adjust the state of the UAV drone countermeasure device, Even if the UAV is too far away and flying too fast or is affected by external environmental factors such as sunlight, rain, wind and sand, the user can still operate the UAV drone countermeasure device smoothly according to the instruction information provided by the electronic device accurately emit interference signals to the UAV, and successfully achieve the task of interfering with UAV.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An unmanned aerial vehicle (UAV) automatic tracking and aiming system, comprising:
a communication unit, configured to obtain a detection information related to a target UAV from a UAV detection system;
an automatic tracking and aiming unit, coupled to the communication unit and configured to enter a tracking mode for the target UAV and generate an automatic tracking and aiming information according to the detection information; and
an operation interface, coupled to the automatic tracking and aiming unit and configured to provide the automatic tracking and aiming information to assist a user to operate a drone countermeasure device to aim at the target UAV and emit an interference signal.

2. The UAV automatic tracking and aiming system of claim 1, wherein the operation interface is an electronic device externally connected to the drone countermeasure device, or the operation interface is a touch interface or a non-touch interface embedded in the drone countermeasure device.

3. The UAV automatic tracking and aiming system of claim 1, wherein a display screen of the operation interface has a function of displaying whether an elevation or horizontal angle of the drone countermeasure device emitting the interference signal is allowable according to an information about the location and height of restricted area in the surrounding environment assigned by a geographic information system.

4. The UAV automatic tracking and aiming system of claim 1, wherein the detection information comprises coordinates, altitude, height above ground, speed, brand, model, transmission frequency band, transmission bandwidth, transmission power, and receiving noise ratio of the target UAV, distance between the target UAV and the drone countermeasure device, distance between the target UAV and remote control, coordinates and altitude of remote control, coordinates, altitude, transmit power, transmit frequency band, and radiation field pattern of the drone countermeasure device, coordinates, altitude, height above ground, frequency band, orientation, detection distance, antenna radiation field type of detection device, whether the detection function of detection device is enabled, and the electromagnetic shielding condition of the surrounding environment.

5. The UAV automatic tracking and aiming system of claim 1, wherein the UAV automatic tracking and aiming system is embedded in the UAV detection system and enters a tracking mode for the target UAV.

6. The UAV automatic tracking and aiming system of claim 1, wherein in the tracking mode, a crosshair representing an aiming direction of the drone countermeasure device is displayed on a display screen of the operation interface and a recommended interference range generated by the automatic tracking and aiming unit according to the detection information is also displayed on the display screen of the operation interface.

7. The UAV automatic tracking and aiming system of claim 6, wherein when the recommended interference range changes due to a horizontal angle and an elevation angle of the drone countermeasure device, causing the crosshair to be outside the recommended interference range, the drone countermeasure device is correspondingly adjusted by the user to bring the crosshair back within the recommended interference range.

8. The UAV automatic tracking and aiming system of claim 6, wherein the automatic tracking and aiming unit also generates a recommended interference time according to the detection information; if the drone countermeasure device continues to target at least one partial region of the recommended interference range for more than the recommended interference time, the at least one partial region is regarded as a scanned region, and a display state of the at least one partial region on the display screen is changed to remind the user to adjust the drone countermeasure device to target other unscanned regions of the recommended interference range.

9. The UAV automatic tracking and aiming system of claim 6, wherein the automatic tracking and aiming unit also generates a state prompt related to the target UAV according to the detection information and the state prompt is displayed on the display screen to indicate effects of the drone countermeasure device emitting the interference signal to interfere with the target UAV; when the target UAV is in an abnormal state, the state prompt is to change a display state of an aiming region of the drone countermeasure device to indicate that the drone countermeasure device has successfully interfered with the target UAV.

10. The UAV automatic tracking and aiming system of claim 1, wherein the drone countermeasure device is fixedly or non-fixedly disposed.

11. The UAV automatic tracking and aiming system of claim 1, wherein the interference signal emitted by the drone countermeasure device is a composite interference signal comprising different frequencies, bandwidths, powers, phases and modulations; the drone countermeasure device has an automatic interference function, and whether to enable the automatic interference function is set through the operation interface or a switch on the drone countermeasure device; when the automatic interference function is enabled, if the crosshair displayed on the display screen of the operation interface is in an unscanned region or the drone countermeasure device is determined to be aimed at the target UAV, the drone countermeasure device automatically selects the appropriate composite interference signal for jamming based on the detection information; if the crosshair displayed on the display screen of the operation interface is determined not to be within the recommended interference range, the crosshair is not aimed at the target UAV, the target UAV has been successfully interfered, or the target UAV has lost its threat (has returned, landed, and is outside the warning range), then the drone countermeasure device automatically stops jamming.

12. The UAV automatic tracking and aiming system of claim 1, wherein the drone countermeasure device has an interference protection function, and whether to enable the interference protection function is set through the operation interface or a switch on the drone countermeasure device; when the interference protection function is enabled, the UAV detection system temporarily disables some or all of detection functions, so that the automatic tracking and aiming system can remove some or all of interference restrictions; if the automatic tracking and aiming system determines that an interference direction of the drone countermeasure device affects the detection device based on the detection information, the interference limitation function is triggered and a warning is issued on the operation interface; when the interference limitation function is triggered, some or all of the interference functions of the drone countermeasure device are limited and the interference limitation function can be manually released through the operation interface.

13. An unmanned aerial vehicle (UAV) automatic tracking and aiming method, comprising steps of:
obtaining a detection information related to a target UAV from a UAV detection system;
entering a tracking mode for the target UAV and generating an automatic tracking and aiming information according to the detection information; and
providing the automatic tracking and aiming information to assist a user to operate a drone countermeasure device to aim at the target UAV and emit an interference signal.

14. The UAV automatic tracking and aiming method of claim 13, wherein the detection information comprises coordinates, altitude, height above ground, speed, brand, model, transmission frequency band, transmission bandwidth, transmission power, and receiving noise ratio of the target UAV, distance between the target UAV and the drone countermeasure device, distance between the target UAV and remote control, coordinates and altitude of remote control, coordinates, altitude, transmit power, transmit frequency band, and radiation field pattern of the drone countermeasure device, coordinates, altitude, height above ground, frequency band, orientation, detection distance, antenna radiation field type of detection device, whether the detection function of detection device is enabled, and the electromagnetic shielding condition of the surrounding environment.

15. The UAV automatic tracking and aiming method of claim 13, wherein the UAV automatic tracking and aiming method further comprises steps of:
entering the tracking mode for the target UAV;
displaying a crosshair representing an aiming direction of the drone countermeasure device in a crosshair of a display screen;
displaying a recommended interference range generated according to the detection information on the display screen; and
displaying whether an elevation or horizontal angle of the drone countermeasure device emitting the interference signal is allowable according to an information about the location and height of restricted area in the surrounding environment assigned by a geographic information system.

16. The UAV automatic tracking and aiming method of claim 15, further comprising steps of:
when the recommended interference range changes due to a horizontal angle and an elevation angle of the drone countermeasure device, causing the crosshair to be outside the recommended interference range, correspondingly adjusting the drone countermeasure device to bring the crosshair back within the recommended interference range.

17. The UAV automatic tracking and aiming method of claim 15, further comprising steps of:
generating a recommended interference time according to the detection information;
if the drone countermeasure device continues to target at least one partial region of the recommended interference range for more than the recommended interference time, regarding the at least one partial region as a scanned region; and
changing a display state of the at least one partial region on the display screen to remind the user to adjust the drone countermeasure device to target other unscanned regions of the recommended interference range.

18. The UAV automatic tracking and aiming method of claim 15, further comprising steps of:
generating a state prompt related to the target UAV according to the detection information and displaying the state prompt on the display screen to indicate effects of the drone countermeasure device emitting the interference signal to interfere with the target UAV;
wherein when the target UAV is in an abnormal state, the state prompt is to change a display state of an aiming region of the drone countermeasure device to indicate that the drone countermeasure device has successfully interfered with the target UAV.

19. The UAV automatic tracking and aiming method of claim 13, wherein the drone countermeasure device is fixedly or non-fixedly disposed; the interference signal emitted by the drone countermeasure device is a composite interference signal including different frequencies, bandwidths, powers, phases and modulations; the UAV automatic tracking and aiming method further comprising steps of:
enabling the automatic interference function of the drone countermeasure device;
if the crosshair of the operation interface is in an unscanned region or the drone countermeasure device is determined to be aimed at the target UAV, the drone countermeasure device automatically selecting the appropriate composite interference signal for jamming based on the detection information; and
if the crosshair of the operation interface is determined not to be within the recommended interference range, the crosshair is not aimed at the target UAV, the target UAV has been successfully interfered, or the target UAV has lost its threat (has returned, landed, and is outside the warning range), then the drone countermeasure device automatically stopping jamming.

20. The UAV automatic tracking and aiming method of claim 13, further comprising steps of:
enabling the interference protection function;
the UAV detection system temporarily disabling some or all of detection functions, so that the automatic tracking and aiming system can remove some or all of interference restrictions;
if the automatic tracking and aiming system determines that the interference direction of the drone countermeasure device affects the detection device based on the detection information, triggering the interference limitation function and issuing a warning on the operation interface; and
when the interference limitation function is triggered, limiting some or all of the interference functions of the drone countermeasure device and the interference limitation function can be manually released through the operation interface.
